(19) United States
(12) Patent Application Publication
(10) Pub. No.: US 2008/0294838 A1
(43) Pub. Date: Nov. 27, 2008

(54) UNIVERSAL BOOT LOADER USING PROGRAMMABLE ON-CHIP NON-VOLATILE MEMORY

(75) Inventors: Alexandra Houston, Munich (DE); Martin Lohse, Gauting (DE); Thomas Ostendorf, Munich (DE); Sujoy Ray, Munich (DE); Kenneth Tuchman, Munich (DE)

Correspondence Address: MENDELSOHN & ASSOCIATES, P.C., 1500 JOHN F. KENNEDY BLVD., SUITE 405, PHILADELPHIA, PA, 19102, US

(73) Assignee: AGERE SYSTEMS INC., Allentown, PA (US)

(21) Appl. No.: 11/966,270

(22) Filed: Dec. 28, 2007

Related U.S. Application Data
(60) Provisional application No. 60/931,845, filed on May 25, 2007.

(51) Int. Cl. G06F 12/02; G06F 15/177

(52) U.S. Cl. 711/103; 713/2; 711/E12.008

(57) ABSTRACT

In one embodiment, an IC system includes a system on a chip (SoC) adapted to load boot-up code from an external NAND flash memory, which stores the boot-up code. The SoC has a processor, an internal ROM including boot-loading code, an operating RAM, a NAND flash controller (NFC), and an OTP memory. At some point after SoC manufacture, the OTP memory is programmed with parameters needed for communication between the NFC and the external NAND flash memory. This provides a system designer flexibility in choosing a type of external NAND flash memory for the IC system. During SoC power-up, the NFC is initialized with the communication parameters, thereby allowing the NFC to control the NAND flash memory. The boot-loading code directs the processor to load the boot-up code from the external NAND memory onto the operating RAM. The processor then executes the boot-up code from the operating RAM.

This application claims the benefit of the filing date of U.S. provisional application No. 60/931,845 filed on May 25, 2007 as attorney docket no. Houston 1-2-1-1-5, the teachings of which are incorporated herein by reference.

### BACKGROUND OF THE INVENTION

1. Field of the Invention

The current invention relates to semiconductor devices, and in particular, to integrated circuit (IC) systems.

2. Description of the Related Art

An IC device, herein called a chip, traditionally contains a single semiconductor die which has a particular function and which is adapted to interact with other chips and components. For example, a traditional chip might be a microprocessor, a memory controller, or a memory array. A traditional IC system includes two or more chips, as well as other components, each attached to and interconnected through a printed circuit board.

A system on a chip (SoC) comprises two or more IC components in a single integrated device, typically on a single die, where the IC components are interconnected via one or more on-chip data buses. A conventional SoC comprises a microprocessor, internal operating random-access memory (RAM), internal non-programmable read-only memory (ROM), an external-memory controller, and input/output (I/O) interfaces. The internal ROM can store boot-loading code for the microprocessor to execute during boot-up. Some SoCs include one-time-programmable (OTP) memory in order to store an identifier for the IC. The inclusion of several devices in a single SoC allows for the creation of a highly integrated and compact computing system, which allows for greater computing power in a smaller, and possibly cheaper, package.

While the SoC components should have no trouble communicating among each other, the same is not necessarily true with regard to communication between the SoC and external components. Some SoCs communicate with external NAND flash memory devices, which can, for example, be used to store program code for loading onto and use by the SoC. External NAND chips can vary in their communication specifications depending on the particular parameters of the individual NAND chips. Typical NAND-chip parameters that are useful for a corresponding SoC to know are block size, bus width, and address cycle. These parameters may be needed during SoC boot-up, which limits the possible means for the SoC to obtain them.

Since it may be useful for an SoC to interface with different types of NAND chips, several strategies have been developed to enable an SoC to appropriately communicate with a variety of external NAND chips. One solution is to create several variations of an SoC, where each variation is designed to interact with a particular corresponding type of NAND chip. This solution can get very expensive.

Another solution is for the SoC to probe an external NAND chip for the NAND chip's ID and use that ID to determine the NAND chip's configuration information. This can be done, for example, with an on-chip lookup table that correlates an ID to particular configuration information. This solution can become outdated as new NAND devices with new IDs are introduced into the marketplace. The SoC can try to determine a NAND chip's configuration information using complex algorithms, but such algorithms tend to take up extensive chip area when implemented in non-programmable internal ROM, which may be necessary in order to have such algorithms available during SoC boot-up.

### SUMMARY OF THE INVENTION

One embodiment of the invention can be a system on a chip (SoC) for an integrated circuit (IC) system further comprising a first memory external to the SoC. The first memory is adapted to store a first procedure set. The SoC comprises a processor, an operating memory, a controller adapted to control communication with the first memory, and a programmable non-volatile memory adapted to store one or more parameters for use by the controller in controlling the communication with the first memory. The SoC is adapted to use the one or more parameters to load the first procedure set from the first memory onto the operating memory. The processor is adapted to execute the first procedure set stored in the operating memory.

Another embodiment of the invention can be a method for executing a first procedure set by an SoC having (1) a processor, (2) an operating memory, (3) a controller adapted to control communication with a first memory external to the SoC, and (4) a programmable non-volatile memory. The method comprises (a) storing, in the programmable non-volatile memory, one or more parameters for use by the controller in controlling the communication with the first memory, (b) using the one or more parameters to load the first procedure set from the first memory onto the operating memory, and (c) executing the first procedure set stored in the operating memory.

Yet another embodiment of the invention can be an IC system comprising an SoC and a first memory external to the SoC. The first memory is adapted to store a first procedure set. The SoC comprises a processor, an operating memory, a controller adapted to control communication with the first memory, and a programmable non-volatile memory adapted to store one or more parameters for use by the controller in controlling the communication with the first memory. The SoC is adapted to use the one or more parameters to load the first procedure set from the first memory onto the operating memory. The processor is adapted to execute the first procedure set stored in the operating memory.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a simplified block diagram of an IC system in accordance with one embodiment of the present invention.

FIG. 2 shows a table describing an exemplary implementation of a segment of the OTP memory of FIG. 1.

FIG. 3 shows an exemplary flow chart for the boot-up operation of the IC system of FIG. 1.

### DETAILED DESCRIPTION

ICs typically use non-programmable internal ROM to store firmware and other information that does not need to be changed after manufacture. Non-programmable ROM maintains its memory contents regardless of whether it is powered up or not. For example, complementary metal oxide semiconductor (CMOS) ICs can include CMOS-component ROM that is set in the masks used to create the IC. That ROM is consistent across all ICs produced from a particular mask set, and thus is not field- or factory-programmable. However, using non-programmable ROM might not provide sufficient flexibility for providing NAND-chip parameters. Programmable ROM is a type of programmable non-volatile memory, i.e., programmable ROM can be programmed subsequent to manufacture and its memory contents can be maintained even after it is powered off.

In one embodiment of the invention, an SoC uses OTP memory for the programming of parameters, such as external NAND chip parameters, after SoC manufacture—such as during integration with a corresponding external NAND chip. OTP memory refers to a type of programmable non-volatile memory that uses standard CMOS components and can consequently be easily and cheaply integrated with other CMOS circuitry on a single die. OTP memory consequently allows for the relatively simple and inexpensive integration on a CMOS IC of a field-programmable ROM.

Several types of OTP memory have been developed and may be used in the present invention. One example is XPM (from “eXtra Permanent Memory”) from Kilopass Technology, Inc., of Santa Clara, Calif. XPM utilizes standard dual-oxide CMOS technology. XPM uses an antifuse principle for programming, where the conductivity characteristics of programmed components are transformed from a non-conductive state to a conductive state by the application of a sufficiently high voltage or current. An XPM memory cell comprises a thin-oxide transistor, while the programming circuits are constructed using thick-oxide transistors. During programming, particular voltages are applied to selected memory-cell transistors, which cause the gate oxide of those transistors to break down, thus programming the cell.

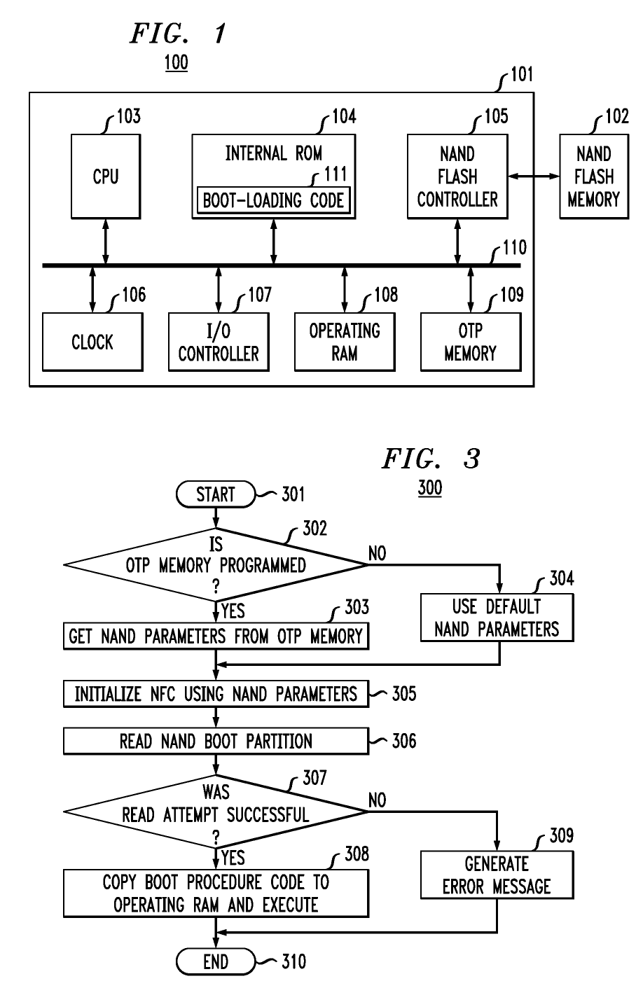

FIG. 1 shows a simplified block diagram of IC system 100 that comprises SoC 101 and external NAND flash memory module 102. SoC 101 comprises central processing unit (CPU) 103, internal ROM module 104, NAND flash controller (NFC) 105, clock module 106, I/O controller 107, operating RAM module 108, OTP memory 109, and data bus 110, which interconnects the aforementioned components of SoC 101. NAND flash controller 105 is connected to, and controls, NAND flash memory module 102.

OTP memory 109 is programmed with communication parameters for NAND flash memory module 102. Since the communication parameters are necessary for a regular boot-up, it is necessary to allow for procedures for programming OTP memory 109 without a regular boot-up. OTP memory 109 can be programmed prior to the first full boot-up by using a special program mode of SoC 101. Alternatively, SoC 101 can be designed to (i) communicate with NAND flash memory module 102 using default or algorithmically derived parameters if OTP memory 109 is not programmed and (ii) then have OTP memory 109 programmed with appropriate parameters. Additional procedures are also possible, as would be appreciated by one of ordinary skill in the art.

IC system 100 allows for the manufacture of multiple identical instances of SoC 101, where each instance can be programmed to communicate with a different type of NAND flash memory module 102. Each instance of SoC 101 can have its OTP memory module 109 programmed with the requisite communication parameters for its corresponding NAND flash memory module 102 as part of the integration process for SoC 101 and corresponding module 102 into IC system 100. The ability to program the communication parameters after manufacture provides the system integrator flexibility in selecting corresponding NAND flash memory module types, including new module types that were unknown at the time of the design and/or manufacture of SoC 101. This flexibility is achieved without requiring complex algorithms in the internal ROM or re-spinning of SoC 101 to create an appropriate SoC variation, where re-spinning includes re-configuring one or more layers of the chip, which requires re-verification of the chip and can be costly in terms of money and time.

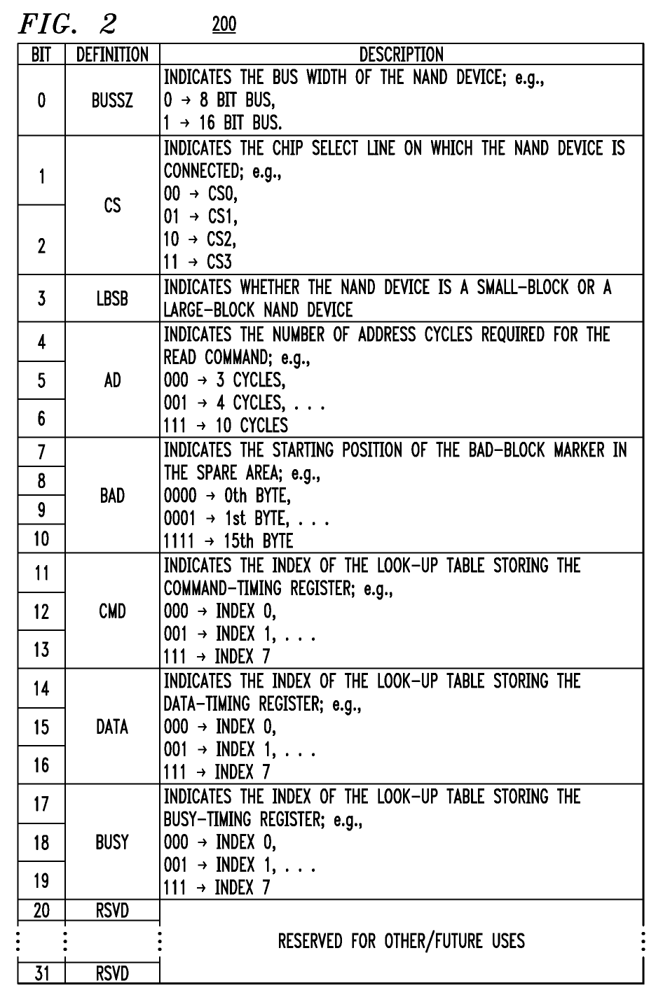

FIG. 2 shows table BA describing an exemplary implementation of a 32-bit segment of OTP memory 109 of FIG. 1, which is used to store communication parameters for NAND flash memory module 102. The bit column comprises the ordinal numbers of the 32 bits in the segment, from 0 to 31. The definition column provides exemplary codes for the contents of the 32 bits, while the description column provides a description of the code. For example, bit 0 is used to store parameter BUSSZ, which indicates the bus width of NAND flash memory module 102, where if BUSSZ is 0, then the bus width is 8 bits, while if BUSSZ is 1, then the bus width is 16 bits. In addition, bits 1 and 2 are used to store parameter CS, which indicates the chip-select line on which the NAND device is connected, wherein a CS of 00 indicates CS0, 01 indicates CS1, 10 indicates CS2, and 11 indicates CS3. Furthermore, bit 3 is used to store block-size parameter LBSB indicating whether NAND flash memory module 102 is a small-block or large-block NAND device, and bits 4-6 are used to store address cycle parameter AD indicating the number of address cycles required for a read command.

Additional communication parameters stored in the exemplary implementation of OTP memory 109 include an indicator of the starting position of the bad-block marker in the spare area of NAND flash memory module 102, and indicators of the indices of the look-up tables storing (i) the data-timing, (ii) busy-timing, and (iii) command-timing registers. Several of the bits of the 32-bit segment of OTP memory 109 illustrated in table BA of FIG. 2 are reserved for future uses.

After OTP memory 109 is programmed with the communication parameters for NAND memory module 102, those parameters can be used by NAND flash controller 105 of SoC 101 for communication with NAND memory module 102. In particular, those parameters are used in the copying of boot-up code from NAND flash memory module 102 into operating RAM 108 during boot-up.

Internal ROM 104 includes boot-loading code 111, which contains a set of instructions to be carried out by CPU 103 after SoC 101 is powered up. In particular, boot-loading code 111 directs CPU 103 to initialize NFC 105 with the communication parameters stored in OTP memory 109 and to load, i.e., copy for execution, boot-up code from NAND flash memory 102 onto operating RAM 108 for execution from RAM 108. The copying is performed using NFC 105, which uses the communication parameters from OTP memory 109. The boot-up code is a procedure set that contains a further set of instructions to be carried out by CPU 103 as part of the boot-up of SoC 101 in order to properly initialize the various components of SoC 101 for normal operation.

FIG. 3 shows exemplary flow chart 300 for boot-loading operation of IC system 100 of FIG. 1. The procedure starts after appropriate power is provided to SoC 101 (step 301). CPU 103 implements boot-loading code 111 to determine whether OTP memory 109 is programmed (step 302). If OTP memory 109 is programmed, then CPU 103 implements boot-loading code 111 to get the NAND parameters from OTP memory 109 (step 303). If OTP memory 109 is not programmed, then CPU 103 implements boot-loading code 111 to use default NAND parameters (step 304). Using either the programmed or default NAND parameters, CPU 103 implements boot-loading code 111 to initialize NFC 105 using the obtained NAND parameters (step 305).

Using NFC 105, CPU 103 implements boot-loading code 111 to attempt to read the NAND boot partition of NAND flash memory 102 (step 306) and determine whether the read attempt was successful (step 307). This determination can be made, for example, by determining whether the data returned in response to the boot-partition read attempt matches a known pattern or is an unknown pattern. If it is determined that the read attempt was successful, then CPU 103 implements boot-loading code 111 to copy the boot procedure code to operating RAM 108 for execution by CPU 103 (step 308), and the boot-loading operation is terminated (step 310). If it is determined that there was a problem with the read attempt, i.e., the read attempt was not successful, then an error message is generated (step 309), and the boot-loading operation is terminated (step 310).

An exemplary embodiment of an IC system has been described that uses particular components; however, the invention is not necessarily limited to the particular components described. As would be appreciated by one of ordinary skill in the art, different components may be substituted. For example, instead of OTP memory, other programmable non-volatile memory, such as programmable ROM (PROM), erasable PROM (EPROM), or electrically erasable PROM (EEPROM), may be used. Furthermore, instead of NAND flash memory, other programmable non-volatile memory may be used for external storage of program code. In one alternative embodiment, instead of NAND flash memory, other memory may be used which requires the initialization of a memory controller with communication parameters, but which may be non-programmable and/or volatile.

An exemplary set of communication parameters has been described; however, the invention is not limited to the particular parameters described. As would be appreciated by one of ordinary skill in the art, different parameters may be used.

An exemplary boot-loading procedure for an embodiment of an IC system in accordance with the invention has been described. However, the invention is not limited to the particular boot-loading procedure described. As would be appreciated by one of ordinary skill in the art, different components could perform the steps described, described steps may be omitted, and new steps may be added, all without departing from the scope of the present invention. Furthermore, in an alternative embodiment of the invention, code other than boot-up code is stored in and loaded from NAND flash memory 102.

An exemplary embodiment of an SoC has been described where boot-loading code 111 is implemented by CPU 103. However, the invention is not so limited. In one alternative embodiment, the boot loader code is implemented by a processor other than CPU 103. The term “processor” as used herein can refer to components comprising two or more processing elements, such as, e.g., a multi-core processor.

The term “nonvolatile memory,” as used herein, refers to any type of memory that substantially retains its stored contents after disconnection from its power supply, i.e., the stored contents can be retrieved after reconnecting the nonvolatile memory to a power supply. Examples of nonvolatile memory include, but are not necessarily limited to (i) fuse/antifuse devices such as OTP memory and PROM, (ii) charge-storing devices such as EPROM and EEPROM and flash ROM, (iii) magnetic media devices such as hard drives and tapes, and (iv) optical, opto-electrical, and opto-magnetic media such as CDs and DVDs.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing steps in a software program. Such software may be employed in, for example, a digital signal processor, micro-controller, or general-purpose computer.

It will be further understood that various changes in the details, materials, and arrangements of the parts which have been described and illustrated in order to explain the nature of this invention may be made by those skilled in the art without departing from the scope of the invention as expressed in the following claims.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless explicitly stated otherwise, each numerical value and range should be interpreted as being approximate as if the word “about” or “approximately” preceded the value of the value or range. As used in this application, unless otherwise explicitly indicated, the term “connected” is intended to cover both direct and indirect connections between elements.

For purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. The terms “directly coupled,” “directly connected,” etc., imply that the connected elements are either contiguous or connected via a conductor for the transferred energy.

The use of figure numbers and/or figure reference labels in the claims is intended to identify one or more possible embodiments of the claimed subject matter in order to facilitate the interpretation of the claims. Such use is not to be construed as limiting the scope of those claims to the embodiments shown in the corresponding figures.

Although the steps in the following method claims are recited in a particular sequence with corresponding labeling, unless the claim recitations otherwise imply a particular sequence for implementing some or all of those steps, those steps are not necessarily intended to be limited to being implemented in that particular sequence.

We claim:

1. A system on a chip (SoC) (e.g., 101) for an integrated circuit (IC) system (e.g., 100) further comprising a first memory (e.g., 102) external to the SoC, wherein:
the first memory is adapted to store a first procedure set; and
the SoC comprises:
a processor (e.g., 103);
an operating memory (e.g., 108);
a controller (e.g., 105) adapted to control communication with the first memory; and
a programmable non-volatile memory (e.g., 109) adapted to store one or more parameters for use by the controller in controlling the communication with the first memory, wherein:
the SoC is adapted to use the one or more parameters to load the first procedure set from the first memory onto the operating memory; and
the processor is adapted to execute the first procedure set stored in the operating memory.

2. The invention of claim 1, wherein:
the operating memory is random-access memory (RAM); and
the programmable non-volatile memory is one-time-programmable (OTP) memory.

3. The invention of claim 1, wherein the first memory is a non-volatile memory.

4. The invention of claim 3, wherein the first memory is NAND flash memory and the controller is a NAND flash controller (NFC).

5. The invention of claim 1, wherein the SoC further comprises internal read-only memory (ROM) that includes boot-loading code.

6. The invention of claim 5, wherein the processor is adapted to use the boot-loading code to:
initialize the controller using the one or more parameters; and
load the first procedure set from the first memory onto the operating memory.

7. The invention of claim 1, wherein the first procedure set is boot-up code and the processor is adapted to use the boot-up code to boot-up the SoC.

8. The invention of claim 1, wherein the one or more parameters include one or more of bus width, block size, and address cycle for the first memory.

9. The invention of claim 1, wherein:
the operating memory is RAM;
the programmable non-volatile memory is OTP memory;
the first memory is NAND flash memory;
the controller is an NFC;
the SoC further comprises internal ROM having boot-loading code;
the processor is adapted to use the boot-loading code to:
initialize the NFC using the one or more parameters; and
load the first procedure set from the NAND flash memory onto the operating RAM;
the first procedure set is boot-up code and the processor is adapted to use the boot-up code to boot-up the SoC; and
the one or more parameters include one or more of bus width, block size, and address cycle for the first memory.

10. The invention of claim 1, wherein the SoC is adapted to:
determine whether the one or more parameters are stored in the programmable non-volatile memory; and
use one or more default parameters in controlling the communication with the first memory if the SoC determines that the one or more parameters are not stored in the programmable non-volatile memory.

11. A method for executing a first procedure set by an SoC (e.g., 101) having (1) a processor (e.g., 103), (2) an operating memory (e.g., 108), (3) a controller (e.g., 105) adapted to control communication with a first memory (e.g., 102) external to the SoC, and (4) a programmable non-volatile memory (e.g., 109), the method comprising:
(a) storing, in the programmable non-volatile memory, one or more parameters for use by the controller in controlling the communication with the first memory;
(b) using the one or more parameters to load the first procedure set from the first memory onto the operating memory; and
(c) executing the first procedure set stored in the operating memory.

12. The method of claim 11, wherein the first memory is NAND flash memory and the controller is an NFC.

13. The method of claim 11, wherein:
the operating memory is RAM; and
the programmable non-volatile memory is OTP memory.

14. An IC system (e.g., 100) comprising a system on a chip (SoC) (e.g., 101) and a first memory (e.g., 102) external to the SoC, wherein:
the first memory is adapted to store a first procedure set; and
the SoC comprises:
a processor (e.g., 103);
an operating memory (e.g., 108);
a controller (e.g., 105) adapted to control communication with the first memory; and
a programmable non-volatile memory (e.g., 109) adapted to store one or more parameters for use by the controller in controlling the communication with the first memory, wherein:
the SoC is adapted to use the one or more parameters to load the first procedure set from the first memory onto the operating memory; and
the processor is adapted to execute the first procedure set stored in the operating memory.

15. The invention of claim 14, wherein the first memory is NAND flash memory and the controller is an NFC.

16. The invention of claim 14, wherein:
the operating memory is operating RAM; and
the programmable non-volatile memory is OTP memory.

17. The invention of claim 14, wherein the SoC further comprises internal ROM that includes boot-loading code.

18. The invention of claim 17, wherein the processor is adapted to use the boot-loading code to:
initialize the controller using the one or more parameters; and
load the first procedure set from the first memory onto the operating memory.

19. The invention of claim 14, wherein:
the operating memory is RAM;
the programmable non-volatile memory is OTP memory;
the first memory is NAND flash memory;
the controller is an NFC;
the SoC further comprises internal ROM having boot-loading code; and
the processor is adapted to use the boot-loading code to:
initialize the NFC using the one or more parameters; and
load the first procedure set from the NAND flash memory onto the operating RAM.

20. The invention of claim 14, wherein the first procedure set is boot-up code and the processor is adapted to use the boot-up code to boot-up the SoC.
